(19) United States
(12) Patent Application Publication
(10) Pub. No.: US 2016/0147057 A1
(43) Pub. Date: May 26, 2016

(54) LENS UNIT AND TRANSMISSION COMPOUND MICROSCOPE

(71) Applicant: NAGAYAMA KUNIAKI, Tokyo (JP)

(72) Inventors: Kuniaki NAGAYAMA, Tokyo (JP); Toshiyuki ITOH, Okazaki-shi, Aichi (JP)

(73) Assignee: Kuniaki NAGAYAMA, Tokyo (JP)

(21) Appl. No.: 14/903,278

(22) PCT Filed: Aug. 15, 2014
(86) PCT No.: PCT/JP2014/071494

§ 371 Date: Jan. 6, 2016

(30) Foreign Application Priority Data
Aug. 16, 2013 (JP) 2013-169294
Nov. 8, 2013 (JP) 2013-232425

(51) Int. Cl. G02B 21/36; G02B 7/02; G03B 17/56

(52) U.S. Cl. CPC G02B 21/362; G03B 17/565; G02B 7/027; G03B 17/566

(57) ABSTRACT

An object of the invention is to provide a lens unit, an illumination cap member, a sample observation kit, and a transmission compound microscope that enable to easily acquire a microscopic observation image by being mounted on a smart device with a simplified structure. A lens unit 10 at least provided with a lens 1, and a holding member 3 which holds the lens 1 is configured such that the lens 1 is disposed on the optical axis of a front camera 22 provided in a smart device 20. The lens 1 of the lens unit 10 and a lens 22a of the camera 22 constitute a transmission compound microscope.

### TECHNICAL FIELD

The present invention relates to a lens unit, an illumination cap member for use with the lens unit, a sample observation kit incorporated with the lens unit and the illumination cap member, and a transmission compound microscope. More specifically, the present invention relates to a technique for performing microscopic observation with use of a smart device having a camera function.

### BACKGROUND ART

The Leeuwenhoek microscope invented by Leeuwenhoek in Holland more than about 350 years ago is the first-ever invented microscope in the world. The Leeuwenhoek microscope has a simple structure provided with a ball lens, and has been favorably used by the people for a long time, because of its high performance and high magnification (100 times to 300 times). The Applicants of the present application simplified the configuration of the Leeuwenhoek microscope, improved the operability, and proposed a single-lens microscope in which the performance was improved by using a high-performance ball lens (see Patent Document 1).

Meanwhile, the Leeuwenhoek microscope may constitute a lens compound microscope when the microscope is integrally used with the lens of an eye of an observer. In recent years, there is proposed a compound microscope, in which the lens of an eye of an observer is substituted by a photographing lens of a smart device having a camera function, such as a smartphone or a tablet terminal (see Non-Patent Documents 1 and 2).

It is reported that the compound microscopes of these new types can effectively use automatic focus or automatic exposure provided in a smart device as camera functions, and can obtain substantially the same performance as the performance of commercially available high-quality microscopes. For the aforementioned reasons, the spread of the Leeuwenhoek single-lens microscope incorporated with a smart device is expected in various fields such as education, medical treatment, healthcare industry, cosmetic industry, food industry, agriculture, forestry, and fishery industries, and entertainment.

### CITATION LIST

### Patent Literature

Patent Document 1: JP-A No. 2004-233930

### Non-Patent Literature

Non-Patent Document 1: David N. Breslauer and other four persons, “Mobile Phone Based Clinical Microscopy for Global Health Applications”, PLoS ONE 4(7): e6320, issued on Jul. 22, 2009
Non-Patent Document 2: Z. J. Smith and other nine persons, “Cell-Phone-Based Platform for Biomedical Device Development and Education Applications”, PLoS ONE 6(3): e17150, issued on Mar. 2, 2011

### SUMMARY OF INVENTION

### Technical Problem

The Leeuwenhoek single-lens microscope incorporated with a smart device as described above has been expected to rapidly spread by adding high functionality of the smart device. However, the Leeuwenhoek single-lens microscope incorporated with a smart device has not yet spread as expected, because of the following problems.

(1) The microscope is provided on the basis of the premises that the microscope is held by the user's hand. Therefore, a photographed image is likely to be blurred due to user's movement. This seems to be a disadvantage due to the fact that a smart device is a mobile device.
(2) As well as a camera, the microscope is a reflective microscope configured such that an object to be observed is observed by reflected light from the object surface, and is not a transmission microscope like a Leeuwenhoek microscope.
(3) A mechanism for fixing a Leeuwenhoek microscope to a smart device is necessary. This makes the mechanism complicated.
(4) When an object to be observed is a sample carried by the user's hand, a sample platform for fixing the sample is necessary. This makes the mechanism complicated.
(5) When an object to be observed is a fixed sample, illumination light may be blocked by a microscope body when the microscope body is moved closer to the sample. In view of the above, it is necessary to prepare an illumination device separately. This makes the mechanism complicated.

In view of the above, an object of the invention is to provide a lens unit, an illumination cap member, a sample observation kit, and a transmission compound microscope that enable to easily acquire a microscopic observation image by being mounted on a smart device with a simplified structure.

### Solution to Problem

A lens unit according to an aspect of the invention is at least provided with a lens, and a holding member which holds the lens. The lens is disposed on an optical axis of a camera provided in a smart device. The lens and the camera constitute a transmission compound microscope.

The lens may be a ball lens or a GRIN lens.

Further, the holding member may be a transparent flat plate including a through-hole formed therein for accommodating the lens. In this configuration, an inner wall of the through-hole may be made opaque.

In the lens unit of the invention, at least an opening portion of the through-hole may be covered by a transparent resin sheet. In this configuration, preferably, a focus position of the lens may be on an outer surface of the transparent resin sheet.

Meanwhile, the lens and the holding member may be integrally formed.

The lens unit of the invention may be further provided with a slip stopper member made of resin or rubber. The slip stopper member may be formed on both or one of a smart-device-side surface of the lens unit, and a sample-side surface of the lens unit. In this configuration, the slip stopper member may include a hole formed therein for receiving at least a part of the lens.

An illumination cap member according to an aspect of the invention is an illumination cap member for use with the lens unit. The illumination cap member includes a cap portion made of an opaque material and configured to cover the lens, and a lighting lens placed on a top surface of the cap portion. A sample is disposed between the lens unit and the lighting lens.

An illumination cap member according to another aspect of the invention is an illumination cap member for use with the lens unit. The illumination cap member includes a cap portion made of an opaque material and configured to cover the lens, and a lighting diffusion plate placed on a top surface of the cap portion. A sample is disposed between the lens unit and the lighting diffusion plate.

Any one of the illumination cap members may further include a Fresnel lens which generates parallel light by using the lighting diffusion plate as a spot light source. In this configuration, a sample is disposed between the lens unit and the Fresnel lens.

The illumination cap member of the invention may further include a slip stopper member made of resin or rubber at a position in contact with the lens unit.

A sample observation kit according to an aspect of the invention includes the lens unit, and the illumination cap member.

The sample observation kit may further include a cover sheet made of a transparent resin and disposed on a sample.

The cover sheet may have such a shape that the cover sheet includes a middle portion of a shape that matches the illumination cap member, and a pair of handle portions formed on both ends of the middle portion.

In the aforementioned configuration, preferably, a lower portion of a side wall of the illumination cap member includes a cutaway at a position that matches the handle portion. The cutaway may have a depth equal to or larger than the thickness of the cover sheet.

A sample observation kit according to another aspect of the invention may be configured such that a through-hole is formed in each of the lens unit and the illumination cap member, and a string member is passed through each of the through-holes.

A microscope according to an aspect of the invention is provided with the lens unit or the sample observation kit; and a smart device having a camera function.

### Advantageous Effects of Invention

According to the invention, it is possible to implement a lens unit that enables to easily acquire a microscopic observation image by being mounted on a smart device with a simplified structure, a sample observation kit incorporated with the lens unit, and a transmission compound microscope incorporated with the lens unit.

### BRIEF DESCRIPTION OF DRAWINGS

FIGS. 1A to 10 are schematic diagrams illustrating a configuration of a lens unit in a first embodiment of the invention, wherein FIG. 1A is a perspective view, FIG. 1B is a plan view, and FIG. 1C is a side view;

FIG. 2A is a perspective view schematically illustrating a configuration of a transmission compound microscope incorporated with a lens unit 10 illustrated in FIG. 1, and FIG. 2B is a side view of the configuration;

FIG. 3A is a perspective view schematically illustrating a configuration of a lens unit as a first modification of the first embodiment of the invention, and FIG. 3B is a side view of the configuration;

FIG. 4 is a side view schematically illustrating a configuration of a lens unit as a second modification of the first embodiment of the invention;

FIG. 5 is a side view schematically illustrating a configuration of a lens unit as a third modification of the first embodiment of the invention;

FIG. 6A is a perspective view schematically illustrating a configuration of a sample observation kit in a second embodiment of the invention, and FIG. 6B is a partially sectional side view of the configuration;

FIG. 7A is a perspective view schematically illustrating a configuration of a sample observation kit in a third embodiment of the invention, and FIG. 7B is a partially sectional side view illustrating how to use the sample observation kit;

FIG. 8A is a perspective view schematically illustrating a configuration of a transmission compound microscope in a fourth embodiment of the invention, and FIG. 8B is a side view of the configuration;

FIGS. 9A to 9D are schematic diagrams illustrating a configuration example of a sample observation kit in a fifth embodiment of the invention;

FIGS. 10A to 10D are schematic diagrams illustrating another configuration example of the sample observation kit in the fifth embodiment of the invention;

FIGS. 11A to 11C are schematic diagrams illustrating yet another configuration example of the sample observation kit in the fifth embodiment of the invention;

FIG. 12A is a side view schematically illustrating a configuration of a lens unit in a sixth embodiment of the invention, and FIG. 12B is an enlarged view illustrating the vicinity of a lens of the lens unit;

FIGS. 13A and 13B are enlarged views illustrating the vicinity of a lens of a lens unit as a modification of the sixth embodiment of the invention;

FIG. 14A is a microphotograph of euglena photographed by a conventional optical microscope, and FIG. 14B is an enlarged view of the microphotograph; and

FIG. 15A is a microphotograph of euglena photographed by a transmission compound microscope of the invention, and FIG. 15B is an enlarged view of the microphotograph.

### DESCRIPTION OF EMBODIMENTS

In the following, embodiments of the invention are described in details referring to the accompanying drawings. It should be noted that the invention is not limited by the embodiments described below.

### First Embodiment

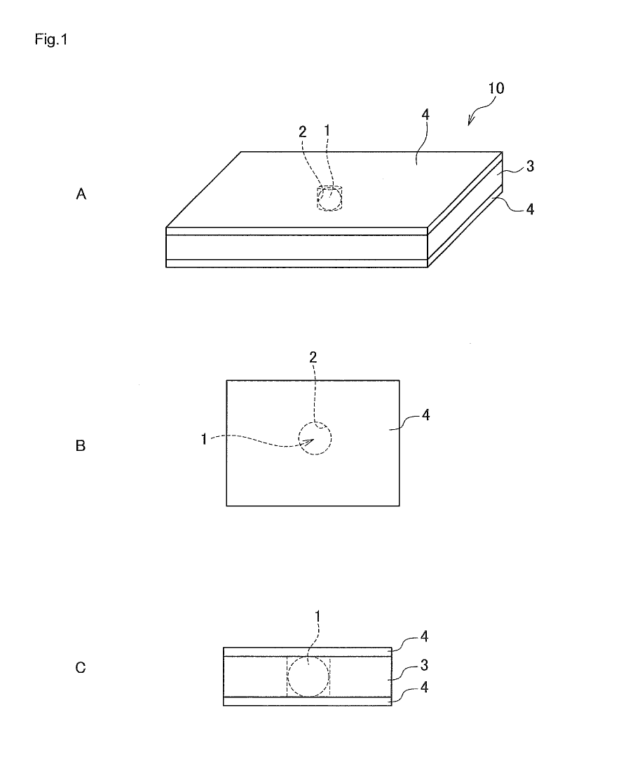

In the following, a lens unit in the first embodiment of the invention is described. FIGS. 1A to 1C are schematic diagrams illustrating a configuration of the lens unit in the embodiment. FIG. 1A is a perspective view, FIG. 1B is a plan view, and FIG. 1C is a side view. As illustrated in FIGS. 1A to 1C, a lens unit 10 in the embodiment is at least provided with a lens 1, and a holding member 3 which holds the lens 1. Thus, the lens unit 10 constitutes a single-lens microscope.

### [Lens 1]

The lens 1 may be a ball lens or a GRIN lens made of glass or plastic. The size of the lens 1 is, for instance, from 1 to 5 mm. As the size of the lens decreases, the focal length decreases, and the magnification of a compound microscope integrally provided with a smart device increases. In view of the above, the size of the lens 1 is selected according to the magnification required by the user.

### [Holding Member 3]

The holding member 3 may be a transparent flat plate or a translucent flat plate. The holding member 3 includes a through-hole 2 formed therein for accommodating the lens 1. In order to facilitate alignment between the optical axis of a camera of a smart device and the optical axis of the lens 1 of the lens unit 10, it is preferable to use a transparent material for the holding member 3. It is desirable, however, to make the holding member 3 opaque by e.g. applying black paint on the inner wall of the through-hole 2 or covering the inner wall of the through-hole 2 with a black sheet in order to prevent incidence of stray light to the lens 1.

Further, the holding member 3 may have a thickness such that the lens 1 does not protrude from the holding member 3 when the lens 1 is accommodated in the through-hole 2. Further, it is possible to color the periphery of the through-hole 2.

### [Transparent Resin Sheet 4]

In the lens unit 10 in the embodiment, preferably, opening portions of the through-hole 2 of the holding member 3 may be respectively covered by a transparent resin sheet 4. The transparent resin sheet 4 may be attached at least to the opening portions of the through-hole 2. As illustrated in FIG. 1A to FIG. 1C, the transparent resin sheet 4 may be formed to cover the entirety of the front surface and the back surface of the holding member 3 (namely, a sample-side surface and a smart-device-side surface). Preferably, the thickness of the transparent resin sheet 4 may be sufficiently smaller than the moving distance of the lens (the distance between the lens surface and a focal point).

When the transparent resin sheet 4 is provided, it is desirable to adjust the position of the lens 1 in such a manner that the focus position of the lens 1 is on the outer surface of the transparent resin sheet 4. In FIG. 1C, the lens 1 is in contact with the transparent resin sheet 4. Alternatively, the lens 1 may not come into contact with the transparent resin sheet 4. It is possible to appropriately set the position of the lens 1, as the focus position is adjusted.

### [How to Use]

Next, a method for performing microscopic observation with use of the lens unit 10 in the embodiment is described. The lens unit 10 in the embodiment is disposed at such a position that the lens 1 is located on the optical axis of a camera provided in a smart device. For instance, when the holding member 3 is formed of a transparent flat plate, the lens unit 10 is disposed at such a position that the window of a camera in a smart device and the lens 1, as viewed via the holding member 3, overlap each other. Thus, the lens 1 of the lens unit 10, and the lens of the camera in the smart device constitute a transmission compound microscope.

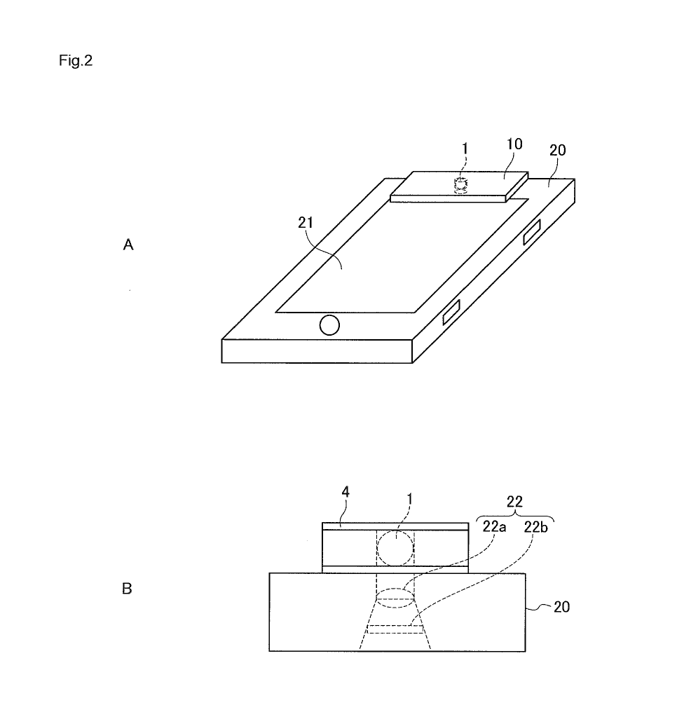

FIG. 2A is a perspective view schematically illustrating a configuration of a transmission compound microscope incorporated with the lens unit 10 illustrated in FIGS. 1A to 1C. FIG. 2B is a side view of the configuration. As illustrated in FIG. 2A, the lens unit 10 in the embodiment is disposed on a front camera 22 provided on the side of a smart device 20 facing an image display surface 21 of the smart device 20. The lens unit 10 illustrated in FIG. 1A and FIG. 1B has a vertically symmetrical configuration. Therefore, it is possible to dispose any one of the front surface and the back surface of the lens unit 10 to face the smart device 20.

Further, as illustrated in FIG. 2B, it is desirable to dispose the lens unit 10 such that the optical axis of the lens 1 and the optical axis of the camera 22 (lens 22a) of the smart device 20 are aligned to each other. Thus, the lens 1 of the lens unit 10, and the lens 22a of the smart device 20 constitute a transmission compound microscope.

When a sample is observed by the transmission compound microscope, the sample as an object to be observed is placed on the transparent resin sheet 4 of the lens unit 10, or is placed on a thin transparent sheet (thus, forming a so-called prepared sample). Then, the transparent sheet is placed on the lens unit 10. The transparent sheet carrying the sample is placed on the lens unit 10 at such a position that the sample is disposed above the lens 1. A microscopic observation image of the sample 2 is acquired by an imaging element 22b of the camera 22 while using, for instance, automatic focus or automatic exposure provided in the camera of the smart device 20.

The lens unit in the embodiment is disposed on the front camera of a smart device. Therefore, when microscopic observation is performed, it is possible to place the smart device on a desk in a stationary state. Thus, an image is not blurred by user's movement. Further, the lens unit in the embodiment has a substantially flat plate shape. Therefore, the lens unit has excellent stability, and a mechanical fixing mechanism for a smart device is not necessary. A compound microscope constituted by the lens unit in the embodiment and a smart device is a transmission microscope like a Leeuwenhoek microscope. The transmission compound microscope is configured such that a sample is placed on the lens unit. Therefore, a sample platform is not necessary. In addition to the above, the lens unit in the embodiment has a simplified structure. Therefore, it is easy to clean the lens unit, and it is possible to wash the lens unit with water.

### First Modification of First Embodiment

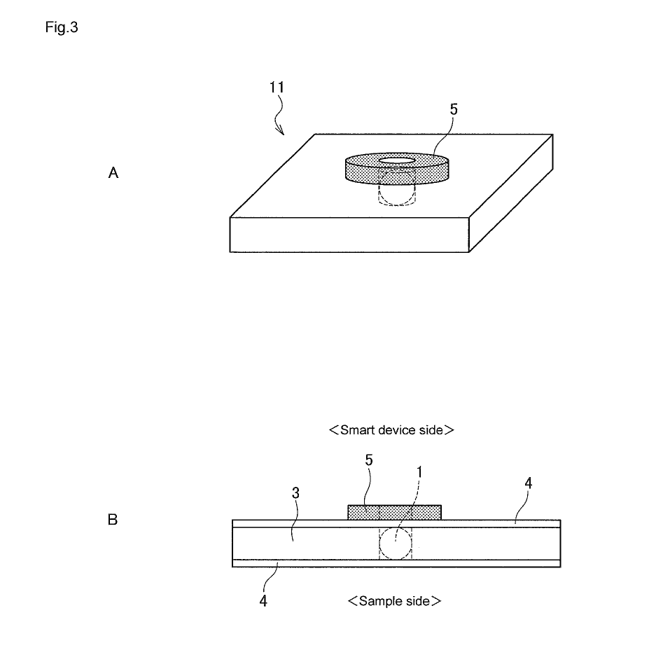

Next, a lens unit as the first modification of the first embodiment of the invention is described. FIG. 3A is a perspective view schematically illustrating a configuration of the lens unit in the modification, and FIG. 3B is a side view of the configuration. The same constituent elements in FIG. 3A and FIG. 3B as the constituent elements of the lens unit 10 illustrated in FIG. 1A and FIG. 1B are indicated with the same reference signs, and detailed description thereof is omitted herein.

The transparent resin sheet 4 has a flat surface, and the coefficient of friction is small. As a result, in some cases, it may be difficult to stably fix the lens unit 10 to the smart device 20. In view of the above, as illustrated in FIG. 3A and FIG. 3B, a lens unit 11 in the modification is provided with a slip stopper member 5 made of resin or rubber on the smart device 20 side surface of the lens unit 11. The thickness of the slip stopper member 5 may be, for instance, from 0.5 to 3 mm, taking into consideration the concave and convex of a housing of a smart device case (such as a step between the display surface and the housing). Preferably, the slip stopper member 5 may be made of silicone rubber having high adhesiveness to a resin material forming the display surface of the smart device.

Providing the slip stopper member 5 as described above makes it possible to enhance stability in fixing the lens unit 11. It is easy to fix the lens unit 11 in the modification merely by positioning the window of the front camera 22 of the smart device 20 and the lens 1 to each other, and pressing the lens 1 toward the smart device 20.

### Second Modification of First Embodiment

Next, a lens unit as the second modification of the first embodiment of the invention is described. FIG. 4 is a side view schematically illustrating a configuration of the lens unit in the modification. The same constituent elements in FIG. 4 as the constituent elements of the lens unit 11 illustrated in FIG. 3A and FIG. 3B are indicated with the same reference signs, and detailed description thereof is omitted herein.

As illustrated in FIG. 4, a lens unit 12 in the modification is configured such that a slip stopper member 6 made of resin or rubber is embedded in a resin sheet 4 formed on the sample-side surface of the lens unit 12. The thickness of the slip stopper member 6 may be 0.5 mm, for instance. Further, it is preferable to use silicone rubber having high adhesiveness to a glass material or a resin material for use in forming a prepared sample, as a material for the slip stopper member 6. Providing the slip stopper member 6 on the sample-side surface of the lens unit 12 as described above makes it possible to fix the lens unit 12 merely by pressing a prepared sample toward the surface of the lens unit 12. This is advantageous in enhancing stability in holding a sample.

### Third Modification of First Embodiment

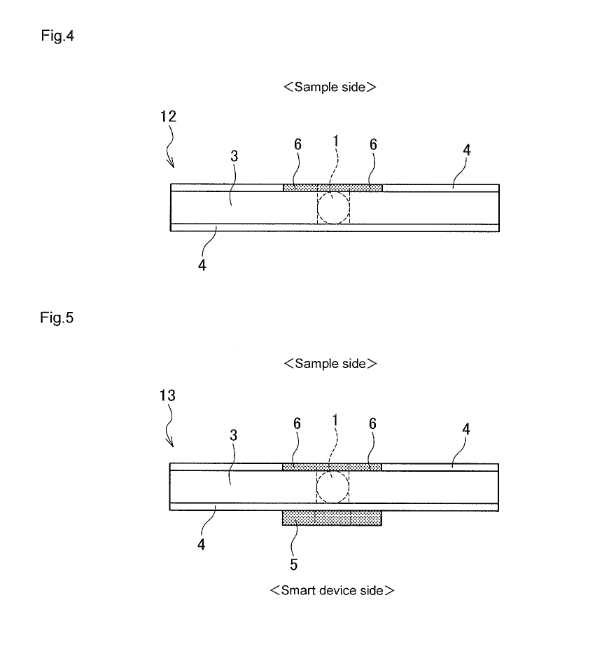

Next, a lens unit as the third modification of the first embodiment of the invention is described. FIG. 5 is a side view schematically illustrating a configuration of the lens unit in the modification. The same constituent elements in FIG. 5 as the constituent elements of the lens unit 11 illustrated in FIG. 3A and FIG. 3B are indicated with the same reference signs, and detailed description thereof is omitted herein.

As illustrated in FIG. 5, a lens unit 13 in the modification is configured such that a slip stopper member 5 is provided on the device-side surface of the lens unit 13, and a slip stopper member 6 is embedded in a resin sheet 4 formed on the sample-side surface of the lens unit 13. According to this configuration, both of the advantageous effects of the first modification and of the second modification are obtained. Thus, the lens unit 13 illustrated in FIG. 5 is most advantageous in operability.

### Second Embodiment

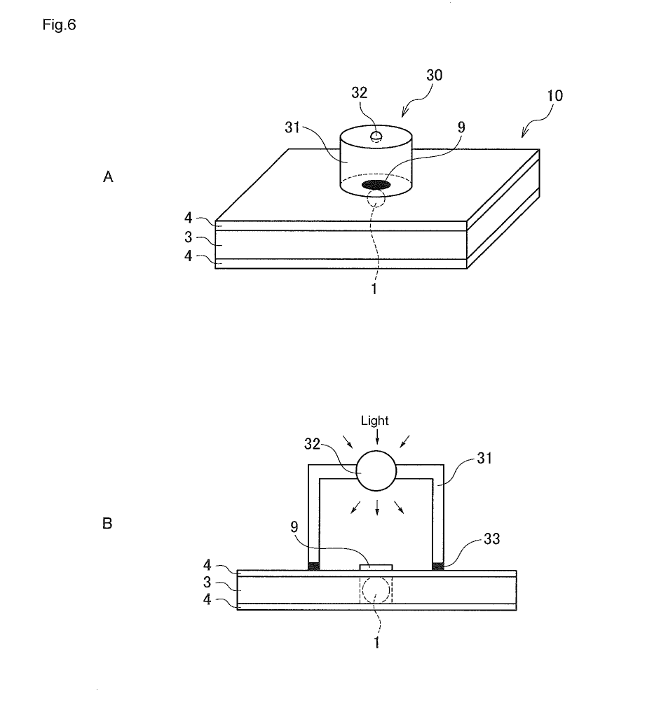

Next, a sample observation kit in the second embodiment of the invention is described. FIG. 6A is a perspective view schematically illustrating a configuration of the sample observation kit in the embodiment, and FIG. 6B is a partially sectional side view of the configuration. The same constituent elements in FIG. 6A and FIG. 6B as the constituent elements of the lens unit 10 illustrated in FIG. 1A and FIG. 1B are indicated with the same reference signs, and detailed description thereof is omitted herein.

When a transmission microscope is used, the illumination method affects the performance of the microscope. As the illumination methods for a sample, there are known critical illumination in which a light source image is formed on a sample surface, and Koehler illumination in which illumination has no relationship with the size or the shape of a light source. The sample observation kit in the embodiment employs Koehler illumination. Specifically, as illustrated in FIG. 6A and FIG. 6B, the sample observation kit in the embodiment is provided with the lens unit 10 in the first embodiment, and an illumination cap member 30. The illumination cap member 30 functions as Koehler illumination.

### [Illumination Cap Member 30]

The illumination cap member 30 is constituted by a cap portion 31 made of an opaque material, and a lighting lens 32 placed on the top surface of the cap portion 31. An example of the lighting lens 32 is a ball lens. As illustrated in FIG. 4A and FIG. 4B, the illumination cap member 30 is disposed on the lens unit 10 in such a manner that the illumination cap member 30 covers the lens 1 of the lens unit 10 and a sample 9 placed on the lens 1. Thus, the sample 9 for observation is disposed between the lens unit 10 and the lighting lens 32.

As described above, when the illumination cap member 30 is placed on the sample 9, the sample 9 is subjected to Koehler illumination by the operation of the lighting lens 32, no matter where a light source is placed. Further, the illumination cap member 30 is a member independent of the lens unit 10, and it is possible to place the illumination cap member 30 at any position. Therefore, it is possible to search an optimum illumination position by moving the illumination cap member 30 with respect to a light source image in an oblique direction, for instance.

Preferably, a slip stopper member 33 made of rubber may be provided on a bottom surface of the illumination cap member 30 (a surface in contact with the lens unit 10) so that the illumination cap member 30 is not easily moved after being placed. It is preferable to use silicone rubber having high adhesiveness to a resin material forming a holding member 3 or a transparent resin sheet 4, as a material for the slip stopper member 33.

Further, it is preferable to adjust the height of the illumination cap member 30 such that the distance between the lower end of the lighting lens 32 (the sample-side end portion), and a sample is in the range of from 3 to 10 mm. An illumination effect can be obtained even when a hollow pinhole is formed in the top surface of the cap portion 31, in place of installing the lighting lens 32. In this case, however, it is necessary to adjust the position of the illumination cap member 30, taking into consideration the positional relationship between a light source and a sample. In view of the above, the lighting lens 32 is used for the illumination cap member 30 of the sample observation kit in the embodiment.

In FIG. 6A and FIG. 6B, the lens unit 10 in the first embodiment is used. The invention, however, is not limited to the above. It is possible to use any one of the lens units 11 to 13 in the first to third modifications of the first embodiment. In this case, it is possible to obtain the aforementioned advantageous effects as well as the aforementioned embodiment.

### Third Embodiment

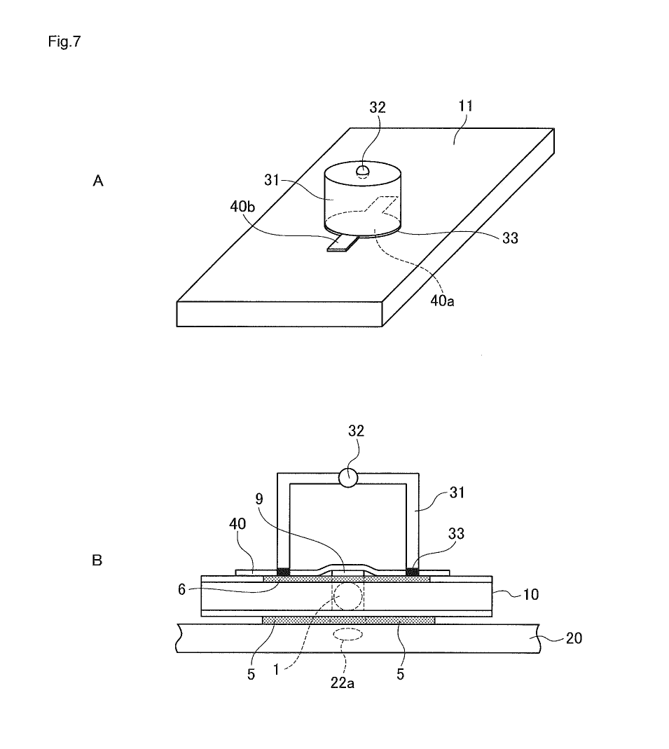

Next, a sample observation kit in the third embodiment of the invention is described. FIG. 7A is a perspective view schematically illustrating a configuration of the sample observation kit in the third embodiment of the invention. FIG. 7B is a partially sectional side view illustrating how to use the sample observation kit. The same constituent elements in FIG. 7A and FIG. 7B as the constituent elements of the lens unit 11 illustrated in FIG. 2A and FIG. 2B are indicated with the same reference signs, and detailed description thereof is omitted herein.

As illustrated in FIG. 7A and FIG. 7B, the sample observation kit in the embodiment is provided with a lens unit 11, an illumination cap member 30, and a sample observation sheet 40. A lens 1 of the lens unit 11 is small, and the focal length and the moving distance of the lens 1 are extremely small. As a result, it may be difficult to focus depending on where a sample is placed, for instance, a case in which a sample does not come into firm contact with the lens unit 11.

In view of the above, the sample observation kit in the embodiment is provided with the transparent cover sheet 40 for covering a sample. The cover sheet 40 has substantially the same function as a so-called sample cover glass. The thickness of the cover sheet 40 may be appropriately set depending on the specifications of the lens unit 11 (such as the focal length of the lens 1 or the thickness of the transparent resin sheet 4). For instance, the thickness of the cover sheet 40 may be about 0.2 mm.

As illustrated in FIG. 7A, after the cover sheet 40 is placed on the sample 9, the cover sheet 40 is fixed by being pressed by the illumination cap member 30. The shape of the cover sheet 40 is not specifically limited. For instance, a middle portion 40a of the cover sheet 40 may have such a size that the middle portion 40a is located within the illumination cap member 30, and that rectangular handle portions 40b of the cover sheet 40 extend from the middle portion 40a leftward and rightward. As illustrated in FIG. 7B, when the cover sheet 40 having the aforementioned configuration is used, the middle portion 40a is placed on the sample 9, and the handle portions 40b are engaged in a groove of the illumination cap member 30. Subsequently, the illumination cap member 30 is pressed toward the cover sheet 40 from above for fixation.

Further, a cutaway of a size corresponding to the width of the handle portion 40b of the cover sheet 40 may be formed in two positions facing the lower portion of the side surface of the illumination cap member 30 so that the handle portions 40b of the cover sheet 40 are fixed by the cutaways. In this case, preferably, the depth of the cutaway may be such that the sum of the depth of the cutaway and the thickness of the slip stopper member 33 of the illumination cap member 30 is equal to or larger than the thickness of the cover sheet 40.

FIG. 7A and FIG. 7B illustrate an example, in which the lens unit 11 as the first modification of the first embodiment is used. The invention, however, is not limited to the above. It is possible to use any one of the lens unit 10 in the first embodiment, the lens unit 12 in the second modification, and the lens unit 13 in the third modification. In any case, advantageous effects as described above can be obtained as well as the aforementioned embodiment.

### Fourth Embodiment

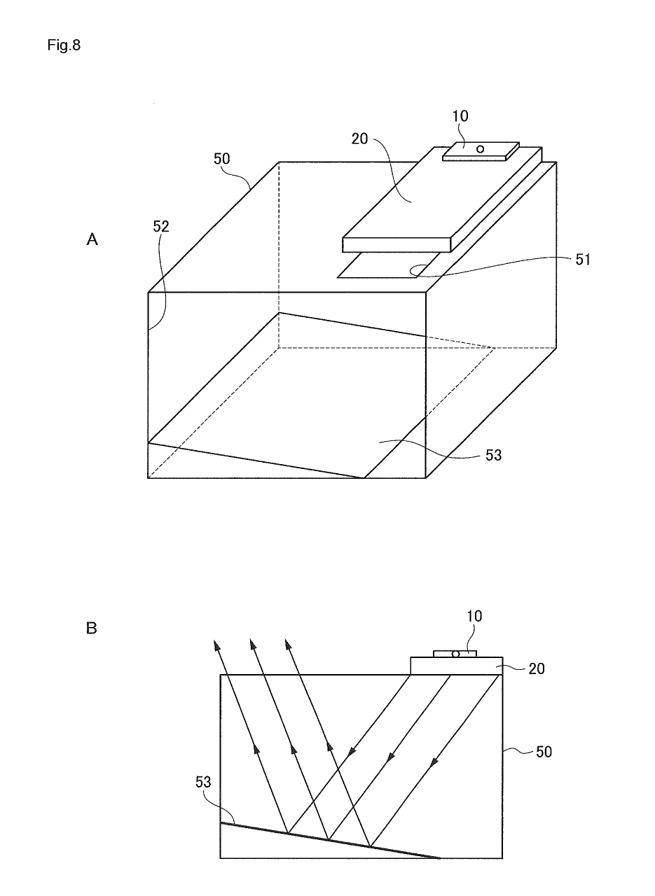

Next, a transmission compound microscope in the fourth embodiment of the invention is described. FIG. 8A is a perspective view schematically illustrating a configuration of the transmission compound microscope in the embodiment, and FIG. 8B is a side view of the configuration. In the first embodiment described above, the lens unit 10 is disposed on the front camera 22 on the display surface 21 side of the smart device 20. It is also possible to use the lens unit of the invention by disposing the lens unit on a rear camera located on the side opposite to the display surface 21 (on the rear surface side of the smart device 20).

In view of the above, as illustrated in FIG. 8A and FIG. 8B, in the transmission compound microscope in the embodiment, there is used a reflection box 50 configured such that opening portions 51 and 52 are respectively formed in the upper surface and in a side surface of the reflection box 50, and a plane mirror (reflection plate) 53 is installed therein. The reflection box 50 may be made of transparent acrylic resin, for instance. According to this configuration, even when the lens unit 10 is disposed on the rear camera of the smart device 20, it is possible to observe an image displayed on a display surface through the plane mirror 53 installed in the reflection box 50. Further, the user can touch the display surface through the opening portion 52 formed in the side surface for operation.

In FIG. 8A and FIG. 8B, the lens unit 10 in the first embodiment is used. The invention, however, is not limited to the above. It is possible to use any one of the lens units 11 to 13 in the first to third modifications of the first embodiment. In this case, advantageous effects as described above can be obtained as well as the aforementioned embodiment.

### Fifth Embodiment

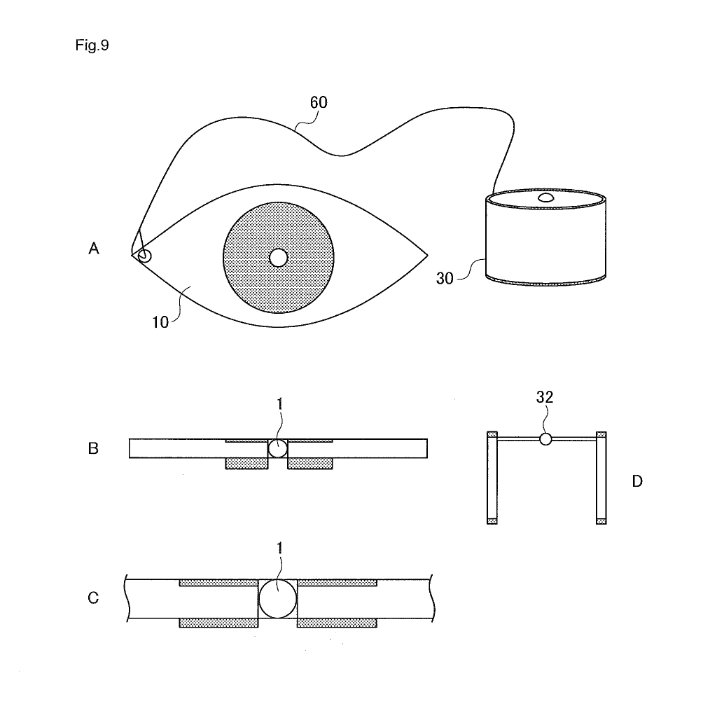

Next, a configuration example of a sample observation kit in the fifth embodiment of the invention is described. FIGS. 9A to 11C illustrate configuration examples of the sample observation kit in the embodiment. As illustrated in FIGS. 9A to 11C, for instance, the sample observation kit in the embodiment may be configured such that a through-hole is formed in each of a lens unit 10 and an illumination cap member 30, and a string member 60 is passed through each of the through-holes for connecting the lens unit 10 and the illumination cap member 30 to each other.

For instance, as illustrated in FIGS. 9A to 9D, a ball lens may be used as a lens 1 of the lens unit 10, and as a lighting lens 32 of the illumination cap member 30.

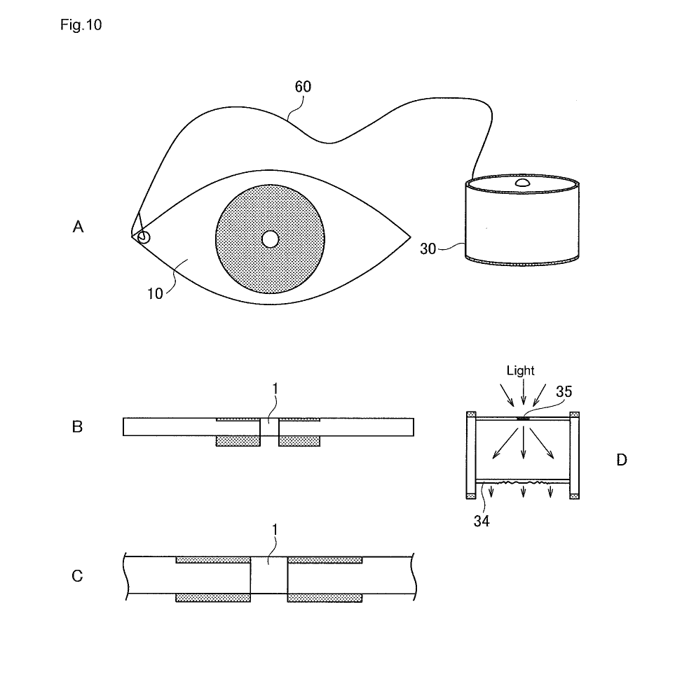

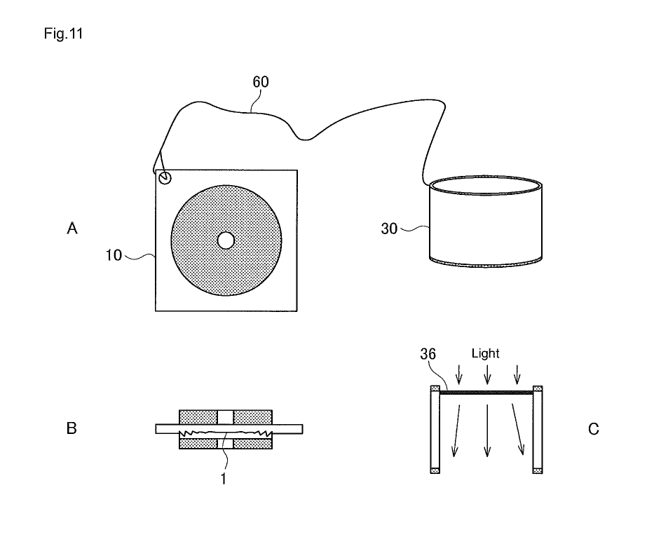

Further, as illustrated in FIGS. 10A to 10D, a GRIN lens may be used as the lens 1 of the lens unit 10; and a small diffusion plate 34 for a spot light source, and a Fresnel lens 35 for obtaining parallel light may be used as the illumination cap member 30. Further, as illustrated in FIGS. 11A to 11C, it is possible to use a Fresnel lens as the lens 1 of the lens unit 10, and to form the top surface of the illumination cap member 30 as a large diffusion plate 36. In any one of the aforementioned configurations, it is possible to easily acquire a microscopic observation image by mounting the lens unit 10 and the illumination cap member 30 on a smart device.

### Sixth Embodiment

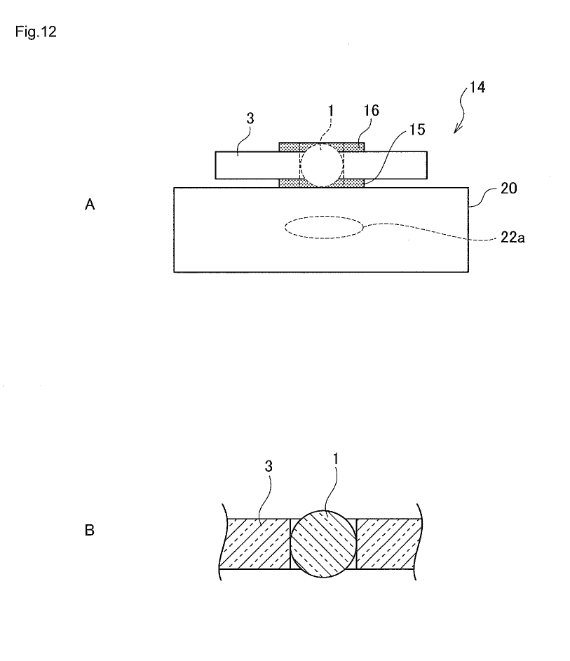

Next, a lens unit in the sixth embodiment of the invention is described. In the lens units in the first embodiment and in the modifications thereof, the lens 1 is accommodated in the holding member 3, and is sealed by the transparent resin sheet 4, as necessary. The invention, however, is not limited to the above. The lens 1 may be exposed from the holding member 3. FIG. 12A is a side view schematically illustrating a configuration of the lens unit in the embodiment, and FIG. 12B is an enlarged view illustrating the vicinity of a lens of the lens unit.

When the lens unit of the invention is used in combination with a smart device, the field of view of an obtained image increases, as the distance between the lens 1 of the lens unit and the lens of the smart device decreases. Thus, the magnification for observation is enhanced to some extent. On the other hand, when a slip stopper member is disposed between the lens 1 and a smart device, as exemplified by the lens unit in the third modification of the first embodiment of the invention illustrated in FIG. 5, the distance between the lens 1 and the lens of the smart device increases by the length corresponding to the thickness of the slip stopper member.

In view of the above, as illustrated in FIG. 12A and FIG. 12B, a lens unit 14 in the embodiment is configured such that a part of a lens 1 projects from a holding member 3 into a hole of a circular shape in plan view, which is formed in the middle portion of slip stopper members 15 and 16. The lens unit 14 is not provided with a transparent resin sheet.

According to the aforementioned configuration, as compared with the lens unit 13 illustrated in FIG. 5, with use of the lens unit 14 in the embodiment, it is possible to shorten the distance between the lens 1 and the lens of the smart device. Further, in the lens unit 14 in the embodiment, the lens 1 is exposed. Therefore, it is easy to wash the lens unit 14 with water. Further, the lens 1 is less likely to be damaged, as compared with a transparent resin sheet. This is advantageous in reducing noise resulting from flaws or scratches.

### Modification of Sixth Embodiment

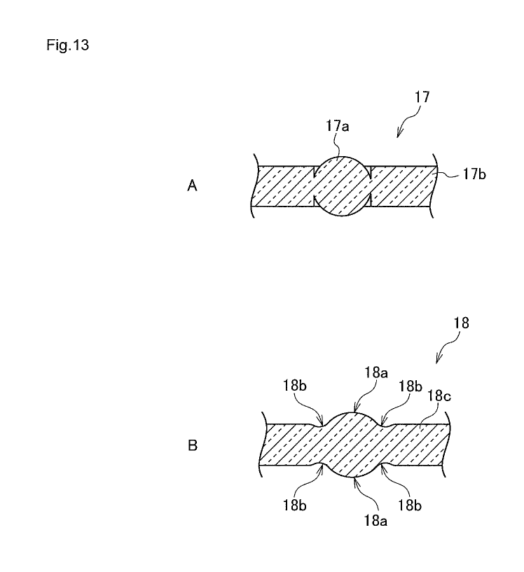

Next, a lens unit as a modification of the sixth embodiment of the invention is described. FIG. 13A and FIG. 13B are enlarged views illustrating the vicinity of a lens of the lens unit in the modification. The lens unit 14 illustrated in FIG. 12B is configured such that the lens 1 and the holding member 3 are individual members. The invention, however, is not limited to the above. As exemplified by a lens integrated member 17 illustrated in FIG. 13A, it is possible to integrally form a lens portion 17a and a holding portion 17b.

It is possible to form the lens integrated member as described above by integrally forming with use of resin for an optical lens, for instance. In this method, it is possible to form lens integrated members of various shapes such as an aspherical lens provided with aberration correction. Specifically, a lens portion as illustrated in FIG. 13B is constituted by a spherical lens portion 18a and an aspherical lens portion 18b. It is possible to manufacture the lens integrated member 18 in which the lens portion and a holding portion 18c are integrally formed. With use of these lens integrated members, it is possible to enhance the performance as a microscope.

It is important to secure the material uniformity after molding in manufacturing a high-performance lens. The lens used in the invention is very small. Therefore, it is easy to secure the material uniformity, as compared with a large lens as used in the other microscopes. Thus, it is not particularly necessary to use high-quality optical resin, and only high-precision molding is required. Since the molding technique has already been established, it is possible to manufacture the lens for use in the invention at a low cost.

### EXAMPLES

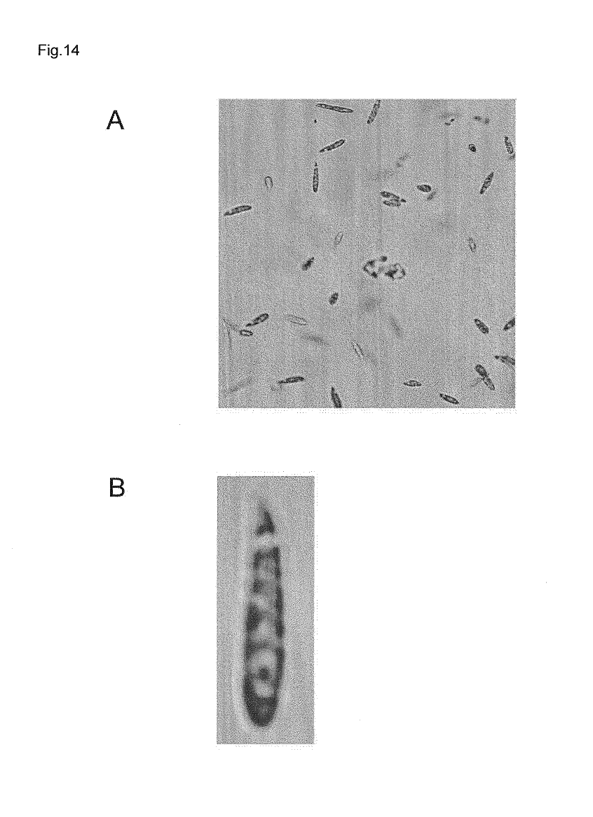

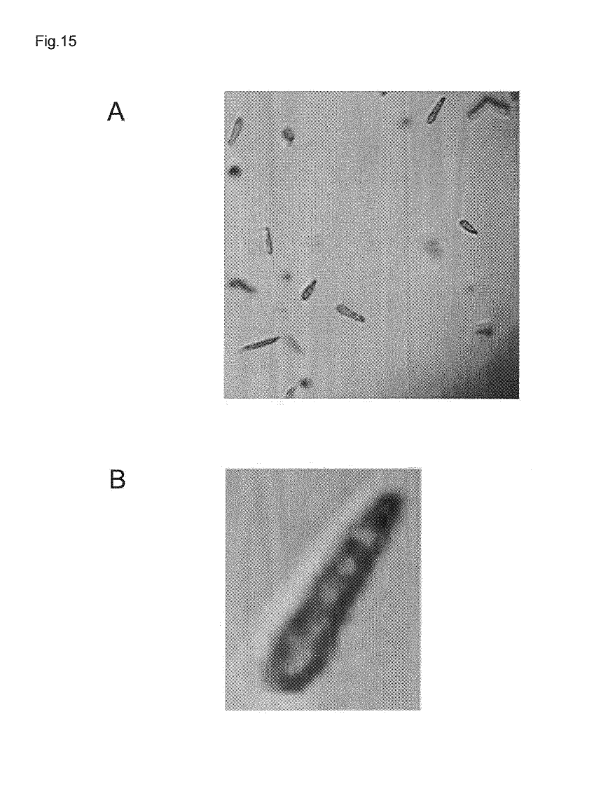

In the following, the advantageous effects of the invention are described by an example of the invention and a comparative example. In the examples, euglena was photographed by a transmission compound microscope incorporated with the lens unit of the invention and a smart device, and by a conventional high-quality optical microscope (ME600 by Nikon Corporation). FIG. 14A is a microphotograph (magnification: 200 times, transmission mode) of euglena photographed by the conventional optical microscope, and FIG. 14B is a partially enlarged view of the microphotograph. FIG. 15A is a microphotograph of euglena photographed by a transmission compound microscope constituted by the inventive lens unit incorporated with a ball lens of 3 mm-diameter, and a commercially available smartphone, and FIG. 15B is a partially enlarged view of the microphotograph.

As illustrated in FIG. 14A and FIG. 15A, the transmission compound microscope incorporated with the inventive lens unit and a smartphone has substantially the same resolution as the conventional high-quality optical microscope. In the enlarged views of euglena illustrated in FIG. 14B and FIG. 15B, the photograph taken by the conventional high-quality optical microscope is clear. However, this is because of the performance of the imaging element. There seems to be no great difference in terms of the performance of a microscope.

### REFERENCE SIGNS LIST

1: Lens
2: Through-hole
3: Holding member
4: Transparent resin sheet
5, 6, 15, 16, 33: Slip stopper member
9: Sample
10 to 14: Lens unit
17, 18: Lens integrated member
17a: Lens portion
17b, 18c: Holding portion
18a: Spherical lens portion
18b: Aspherical lens portion
20: Smart device
21: Display surface
22: Front camera
22a: Lens
22b: Imaging element
30: Illumination cap member
31: Cap portion
32: Lighting lens
34: Fresnel lens
35, 36: Diffusion plate
40: Cover sheet
40a: Middle portion
40b: Handle portion
50: Reflection box
51, 52: Opening portion
53: Plane mirror
60: String member

1. A lens unit, comprising:
a lens; and
a holding member which holds the lens, wherein
the lens is disposed on an optical axis of a camera provided in a smart device, and
the lens and the camera constitute a transmission compound microscope.

2. The lens unit according to claim 1, wherein
the lens is a ball lens or a GRIN lens.

3. The lens unit according to claim 1, wherein
the holding member is a transparent flat plate including a through-hole formed therein for accommodating the lens.

4. The lens unit according to claim 3, wherein
an inner wall of the through-hole is made opaque.

5. The lens unit according to claim 3, wherein
at least an opening portion of the through-hole is covered by a transparent resin sheet.

6. The lens unit according to claim 5, wherein
a focus position of the lens is on an outer surface of the transparent resin sheet.

7. The lens unit according to claim 1, wherein
the lens and the holding member are integrally formed.

8. The lens unit according to claim 1, further comprising:
a slip stopper member made of resin or rubber, wherein
the slip stopper member is formed on both or one of a smart-device-side surface of the lens unit, and a sample-side surface of the lens unit.

9. The lens unit according to claim 8, wherein
the slip stopper member includes a hole formed therein for receiving at least a part of the lens.

10. A transmission compound microscope, comprising:
the lens unit of claim 1; and
a smart device provided with a camera function.

11. The lens unit according to claim 3, wherein
at least an opening portion of the through-hole is covered by a transparent resin sheet.

12. The lens unit according to claim 11, wherein
a focus position of the lens is on an outer surface of the transparent resin sheet.

13. The lens unit according to claim 12, further comprising:
a slip stopper member made of resin or rubber, wherein
the slip stopper member is formed on both or one of a smart-device-side surface of the lens unit, and a sample-side surface of the lens unit.
